(19) United States
(12) Patent Application Publication
(10) Pub. No.: US 2025/0385839 A1
(43) Pub. Date: Dec. 18, 2025

(54) METHODS, DEVICES, AND COMPUTER PROGRAMS FOR FORMING A GROUP OF USER EQUIPMENTS

(71) Applicant: Telefonaktiebolaget LM Ericsson (publ), Stockholm (SE)

(72) Inventors: Mikael COLDREY, Borås (SE); Andreas NILSSON, Göteborg (SE); Sven JACOBSSON, Västra Frölunda (SE); Magnus NILSSON, Kungsbacka (SE); Sam AGNEESSENS, Torslanda (SE)

(73) Assignee: Telefonaktiebolaget LM Ericsson (publ), Stockholm (SE)

(21) Appl. No.: 19/134,809

(22) PCT Filed: Dec. 9, 2022
(86) PCT No.: PCT/EP2022/085227

§ 371 Date: Jun. 2, 2025

(30) Foreign Application Priority Data
Dec. 8, 2022 (WO) PCT/EP2022/084930

(51) Int. Cl. H04L 41/0895; H04L 67/1042; H04W 84/18

(52) U.S. Cl. CPC H04L 41/0895; H04L 67/1042; H04W 84/18

(57) ABSTRACT

There is provided techniques for forming a RVUE constituted by a group of transceiver devices. A method is performed by a transceiver device that is part of the group of transceiver devices. The method comprises providing an indication to a network node in a network that the transceiver device is capable to operate as part of an RVUE. The method comprises receiving RVUE configuration from the network node. The method comprises exchanging, without involving the network, the RVUE configuration with at least one other transceiver device in the group of transceiver devices for the group of transceiver devices to form the RVUE. The method comprises communicating with the network node in accordance with the RVUE configuration.

### TECHNICAL FIELD

Embodiments presented herein relate to methods, a transceiver device, a network node, a computer program, and a computer program product for forming a reconfigurable virtual user equipment (RVUE) constituted by a group of transceiver devices.

### BACKGROUND

Some communication nodes, such as access points or other types of nodes at the network side but also user equipment (UEs) or other types of devices at the user side, can form a network by establishing connectivity between the communication nodes. A network of such communication nodes can constitute of wireless connections, wired connections, or a combination of both. Typically, the communication nodes communicate with each other in the network according to some predefined interface. In general terms, UEs served in a (radio) access network can form a network with other UEs. In such a network, the UEs might communicated directly with each other, or at least without utilizing any cellular connectivity. For example, the UEs might communicate with each other by using Bluetooth connectivity or side-link connectivity.

The network can be static, semi-static or fully flexible with respect to its members. For example, communication nodes could be enabled to join and/or leave semi-static or fully flexible networks. Examples of networks are local computer networks where communication nodes in the form of computers can be added or removed from the local computer network and where communication within the network is facilitated using wired Ethernet links or wireless Wi-Fi links.

Compared to co-located multiple input multiple output (MIMO) systems, distributed MIMO (D-MIMO) systems provide better coverage and multi-user connectivity by making use of joint processing from many access points (for example in terms of Remote Radio Units (RRUs)) that are distributed over a deployment area. The likelihood of a served user being close and having a good connection to one such access point is high. Further, the likelihood of shadowing and the likelihood of having correlated MIMO channels are reduced compared to co-located MIMO systems. Further, D-MIMO systems also bring higher system and link capacity, compared to co-located MIMO systems, at the expense of more complex deployment and more transport needs.

A given UE can have poor connectivity to its serving access points in the serving cellular network due to, e.g., shadowing or interference. Good cellular connectivity, especially at higher frequencies, require a dense network deployment, such as densely deployed co-located MIMO system or even a D-MIMO system. Such systems are complex (in terms of hardware and software) and drives cost. In addition to this, a given UE might need to support many different frequencies, bandwidths, and communication standards which makes the UE complex (in terms of hardware and software), bulky, and costly.

### SUMMARY

An object of embodiments herein is to address the above issues.

According to a first aspect there is presented a method for forming a RVUE constituted by a group of transceiver devices. The method is performed by a transceiver device that is part of the group of transceiver devices. The method comprises providing an indication to a network node in a network that the transceiver device is capable to operate as part of an RVUE. The method comprises receiving RVUE configuration from the network node. The method comprises exchanging, without involving the network, the RVUE configuration with at least one other transceiver device in the group of transceiver devices for the group of transceiver devices to form the RVUE. The method comprises communicating with the network node in accordance with the RVUE configuration.

According to a second aspect there is presented a transceiver device for forming a RVUE constituted by a group of transceiver devices. The transceiver device is part of the group of transceiver devices. The transceiver device comprises processing circuitry. The processing circuitry is configured to cause the transceiver device to provide an indication to a network node in a network that the transceiver device is capable to operate as part of an RVUE. The processing circuitry is configured to cause the transceiver device to receive RVUE configuration from the network node. The processing circuitry is configured to cause the transceiver device to exchange, without involving the network, the RVUE configuration with at least one other transceiver device in the group of transceiver devices for the group of transceiver devices to form the RVUE. The processing circuitry is configured to cause the transceiver device to communicate with the network node in accordance with the RVUE configuration.

According to a third aspect there is presented a transceiver device for forming a RVUE constituted by a group of transceiver devices. The transceiver device is part of the group of transceiver devices. The transceiver device comprises a provide module configured to provide an indication to a network node in a network that the transceiver device is capable to operate as part of an RVUE. The transceiver device comprises a receive module configured to receive RVUE configuration from the network node. The transceiver device comprises an exchange module configured to exchange, without involving the network, the RVUE configuration with at least one other transceiver device in the group of transceiver devices for the group of transceiver devices to form the RVUE. The transceiver device comprises a communicate module configured to communicate with the network node in accordance with the RVUE configuration.

According to a fourth aspect there is presented a computer program for forming a RVUE constituted by a group of transceiver devices. The computer program comprises computer code which, when run on processing circuitry of a transceiver device that is part of the group of transceiver devices, causes the transceiver device to perform actions. One action comprises the transceiver device to provide an indication to a network node in a network that the transceiver device is capable to operate as part of an RVUE. One action comprises the transceiver device to receive RVUE configuration from the network node. One action comprises the transceiver device to exchange, without involving the network, the RVUE configuration with at least one other transceiver device in the group of transceiver devices for the group of transceiver devices to form the RVUE. One action comprises the transceiver device to communicate with the network node in accordance with the RVUE configuration.

According to a fifth aspect there is presented a method for forming a RVUE constituted by a group of transceiver devices. The method is performed by a network node in a network. The method comprises obtaining an indication from at least one of the transceiver devices in the group of transceiver device that said at least one of the transceiver devices is capable to operate as part of an RVUE. The method comprises providing RVUE configuration towards said at least one of the transceiver devices. The method comprises communicating with the RVUE in accordance with the RVUE configuration.

According to a sixth aspect there is presented a network node for forming a RVUE constituted by a group of transceiver devices. The network node comprises processing circuitry. The processing circuitry is configured to cause the network node to obtain an indication from at least one of the transceiver devices in the group of transceiver device that said at least one of the transceiver devices is capable to operate as part of an RVUE. The processing circuitry is configured to cause the network node to provide RVUE configuration towards said at least one of the transceiver devices. The processing circuitry is configured to cause the network node to communicate with the RVUE in accordance with the RVUE configuration.

According to a seventh aspect there is presented a network node for forming a RVUE constituted by a group of transceiver devices. The network node comprises an obtain module configured to obtain an indication from at least one of the transceiver devices in the group of transceiver device that said at least one of the transceiver devices is capable to operate as part of an RVUE. The network node comprises a provide module configured to provide RVUE configuration towards said at least one of the transceiver devices. The network node comprises a communicate module configured to communicate with the RVUE in accordance with the RVUE configuration.

According to an eighth aspect there is presented a computer program for forming a RVUE constituted by a group of transceiver devices. The computer program comprises computer code which, when run on processing circuitry of a network node, causes the network node to perform actions. One action comprises the network node to obtain an indication from at least one of the transceiver devices in the group of transceiver device that said at least one of the transceiver devices is capable to operate as part of an RVUE. One action comprises the network node to provide RVUE configuration towards said at least one of the transceiver devices. One action comprises the network node to communicate with the RVUE in accordance with the RVUE configuration.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide improved connectivity between the network and the coordinated distributed group of transceiver devices compared to the connectivity for a single transceiver device.

Advantageously, these aspects improve the service, network reliability, network availability, and resiliency for the group of transceiver devices compared to a single transceiver device.

Advantageously, these aspects enable one and the same transceiver device to at the same time, or at different times, be part of different groups of transceiver devices, and thus RVUEs, which improves network connectivity sustainability and reduce the requirements on hardware for the transceiver device.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic illustration of a group of transceiver devices according to an example;

FIG. 2 is a schematic illustration of an RVUE according to an embodiment;

FIG. 3 is a schematic illustration of an RVUE communicating with a network node according to an embodiment;

FIG. 4 is a schematic illustration of an RVUE according to an embodiment;

FIGS. 5 and 6 are flowcharts of methods according to embodiments;

FIG. 7 is a schematic diagram showing functional units of a transceiver device according to an embodiment;

FIG. 8 is a schematic diagram showing functional modules of a transceiver device according to an embodiment;

FIG. 9 is a schematic diagram showing functional units of a network node according to an embodiment;

FIG. 10 is a schematic diagram showing functional modules of a network node according to an embodiment; and

FIG. 11 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

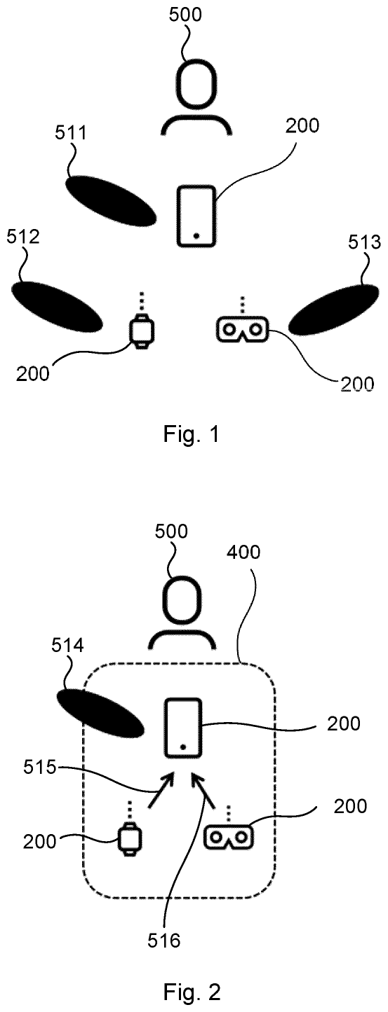

FIG. 1 illustrates a traditional scenario where three different transceiver devices 200 (in terms of a conventional UE, a smart watch and an extended reality (XR headset) belonging to the same user 500 are configured for individual and independent communication, as illustrated by beams 511, 512, 513, with a network. When configured for individual and independent communication with the network, each of the transceiver devices 200 might need to support many different frequencies, bandwidths, and communication standards. This makes the transceiver devices 200 complex (in terms of hardware and software), bulky, and costly.

In contrast to FIG. 1, in FIG. 2 is illustrated a scenario with the same three different transceiver devices 200 as in FIG. 1, but where the transceiver devices 200 are configured to collaborate with each other as a group of transceiver devices. More particularly, the transceiver devices 200 are configured to communicate with each other, as indicated by links 515, 516, but when communicating with the network, the transceiver devices 200 appear one single device, hereinafter referred to as an RVUE 400. This is illustrated by beam 514 used by the RVUE 400 for communicating with the network. The herein disclosed embodiments are based on such a group of transceiver devices 200, together constituting an RVUE 400. An RVUE 400 is thus constituted by a group of transceiver devices 200. Each such transceiver device 200 may or may not have its own individual network identity. It is sufficient that at least one of the transceiver devices 200 has its own individual network identity. For this purpose, at least one of the transceiver devices 200 needs to be provided with a Subscriber Identity Module or Subscriber Identification Module (SIM). The SIM might be provided in terms of a traditional SIM card, or by an embedded SIM (eSIM) or an integrated SIM (iSIM). In some examples, each of the transceiver devices 200 is provided with hardware that enables each of the transceiver devices 200 to independently connect to the network. In this way, even if only one of the transceiver devices 200 is provided with a SIM, all of the transceiver devices 200 can be used for communication with the network when the transceiver devices 200 collaborate with each other as a group of transceiver devices 200 constituting an RVUE 400. In some embodiments, at least one of the transceiver devices 200 in the group of transceiver devices 200 (that constitute an RVUE 400) comprises a cellular modem and has a cellular network identity. In some embodiments, each of the transceiver devices 200 in the group of transceiver devices 200 (that constitute an RVUE 400) comprises a signaling interface for non-cellular communication with other transceiver devices 200 in the group of transceiver devices 200. In some embodiments the the RVUE 400 can be seen as a device-centric network that shares resources. Examples of such resources can be processing, power amplifiers, antennas, identities, etc. In some embodiments, at least one of the transceiver devices 200 in the group of transceiver devices 200 has a network identity, and the network identity is used by the network node 300 when communicating with the RVUE 400 in accordance with RVUE 400 configurations. Examples of RVUE 400 configuration will be disclosed below. For alternative characterizations of an RVUE 400 and related technical information, reference is made to the applicant's parallel disclosures [applicant reference: P106126WO01] and [applicant reference: P106173WO01], which are hereby incorporated by reference.

The transceiver devices 200 are operatively connectable to each other via any proprietary or standardized, wired, or wireless, technology. The transceiver device 200 of each RVUE 400 can belong to the same user or can be shared between multiple users. By forming a RVUE 400, the connection to the network for the transceiver devices 200 is improved compared to the connection to the network for just one single transceiver device 200. The RVUE 400 enables diversity and/or multiplexing over multiple spatially separated devices. Each transceiver device 200 can have its own unique characteristics, for example, having its operations optimized for a certain frequency band or deployment location. Some non-limiting examples of transceiver devices 200 are consumer premises equipment (CPEs), UEs (such as mobile phones, tablet computers, laptop computers, etc.), smart wearables (such as smart watches, smart glasses, etc.), relays, repeaters, modems, routers, remote radio units (RRUs), network connectible vehicles (such as unmanned aerial vehicles, self-driving cars, etc.), network connectible machines and industry equipment, etc. As a first non-limiting example, consider a set of smart wearables operatively connected to one and the same UE. The smart wearables and the UE could then constitute a RVUE 400. As a second non-limiting example, consider a set of communication equipment composed of a UE, a tablet computer, and a laptop computer belonging to one and the same user. The set of communication equipment could then constitute an RVUE 400. As a third non-limiting example, consider a set of communication equipment composed of a modem, a router, and a computer connected to one and the same local-area network. The set of communication equipment could then constitute an RVUE 400. As a fourth non-limiting example, consider a set of communication equipment composed of two or more UEs, tablet computers, laptop computers, etc. placed in one and the same vehicle (such as a car, a bus, a train car, etc.). The set of communication equipment could then constitute an RVUE 400. As a fifth non-limiting example, consider a set of communication equipment composed of one or more UEs and a network connectible vehicle, where the one or more UEs are placed in the network connectible vehicle. In this respect, the hardware capabilities of the network connectible vehicle can be much better than for the UEs, in terms of more output power, better synchronization between transmitters, more and larger antenna panels, antenna panels placed on the exterior of the vehicle with line of sight to the serving access point, etc. In this case, the UEs and the network connectible vehicle may be configured as a RVUE 400, where data from all the communication equipment is routed to the network via the network connectible vehicle. As a sixth non-limiting example, consider a set of communication equipment composed of integrated access and backhaul (IAB) nodes operatively connected to the same donor IAB node. The IAB nodes could then constitute an RVUE 400. Each IAB node is equipped with at least one antenna port for communication with the network, whereas the transmission between the IAB nodes and the donor IAB node is performed via the Uu interface. The IAB nodes can be connected to each other over an alternative interface and, hence, can exchange data with each other without the network being involved.

In some examples, one of the transceiver devices 200 constituting the RVUE 400 acts as a coordinating transceiver device 200 in the group of the transceiver devices 200. This coordinating transceiver device 200 might then be configured for coordinating joint processing and transmission/reception over the group of the transceiver devices 200.

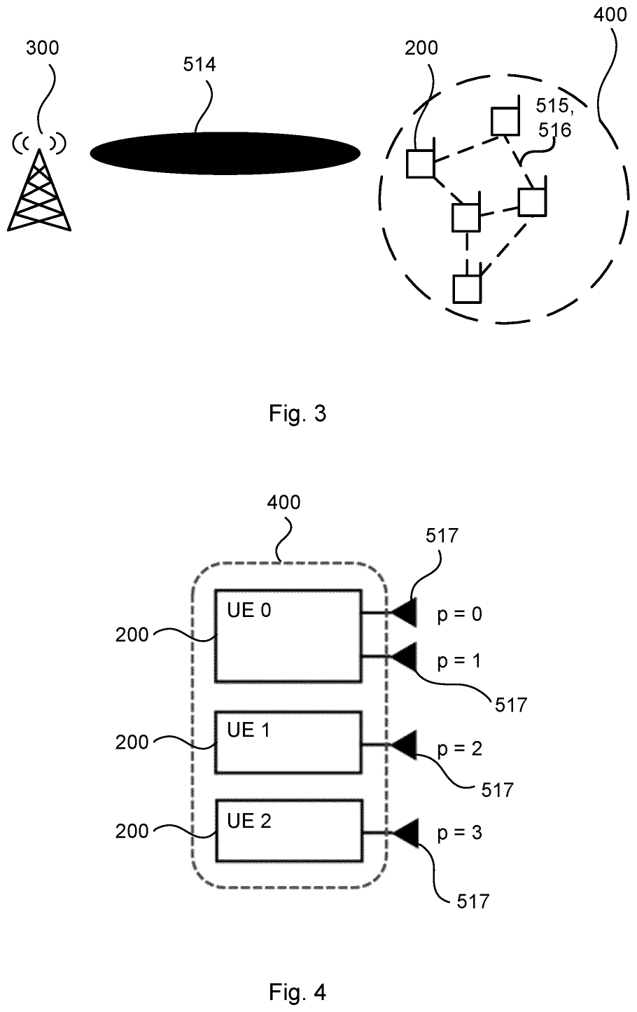

In FIG. 3 is illustrated a scenario where transceiver devices 200, by means of the RVUE 400, communicate in a beam 514 with a network node 300. The network node 300 could be any of a (radio) access network node, radio base station, base transceiver station, node B (NB), evolved node B (eNB), gNB, access point, etc. Since the RVUE 400 is constituted by spatially separated devices with possibly different connection capabilities, the likelihood of good network connectivity thanks to spatial diversity and/or multiplexing over transceiver devices 200 is increased compared to the network capability per each individual transceiver device 200. The network node 300 would recognize the RVUE 400 as a single transceiver device 200 but with possibly increases capacity and/or capability compared to an individual transceiver device 200. This could be useful for adding spatial diversity and/or multiplexing to improve performance without exposing each individual transceiver device 200 to the network

In general terms, combinations of transceiver devices 200 with different capabilities yield different capabilities of the RVUE 400. One example of this is illustrated in FIG. 4. In FIG. 4 is illustrated an example RVUE 400 with four antennas 517 in total, The RVUE 400 is constituted by a smartphone (UE 0), a smart watch (UE 1) and an XR headset (UE 2), where the smartphone (UE 0) has one dual-port antenna panel (p=0 and p=1), the smart watch (UE 1) has one single-port antenna panel (p=2), and the XR headset (UE 2) has one single-port antenna panel (p=3) for communicating with the network. When operating as individual devices, the devices thus have either one or two antenna ports for communicating with the network. By forming an RVUE 400, the devices now instead share a total of four antenna ports (p=0, . . . p=3) for communicating with the network.

In some examples, a transceiver device 200 is already registered by the network, then such a transceiver device 200 should inform the network, as represented by the network node 300, that it will join a RVUE 400. One handshake procedure might be performed between the network, as represented by the network node 300, and the transceiver device 200, and one handshake procedure might be performed between the RVUE 400, as represented by a coordinating transceiver device 200, and the transceiver device 200, that the transceiver device 200 will join the RVUE 400.

In some examples, the group of transceiver devices 200 can decide themselves to form a RVUE 400. In other examples, the network, as represented by the network node 300, instructs the group of transceiver devices 200 to form a RVUE 400 based on some criteria. For example, the network node 300 could include in a RVUE 400 a transceiver device that has a poor network connection, where at least one other transceiver devices in the RVUE 400 has good network connection.

In some examples, at least some of the transceiver devices 200 in the group of transceiver devices 200 that constitute a RVUE 400 can at the same time also be part of another group of transceiver devices 200 and constitute another RVUE 400.

Dissolving a RVUE 400 is in principle the reverse of forming a RVUE 400. One handshake procedure might be performed between the RVUE 400, as represented by a coordinating transceiver device 200, and the transceiver device 200, and one handshake procedure might be performed between the network, as represented by the network node 300, and the transceiver device 200, that the transceiver device 200 will leave the RVUE 400.

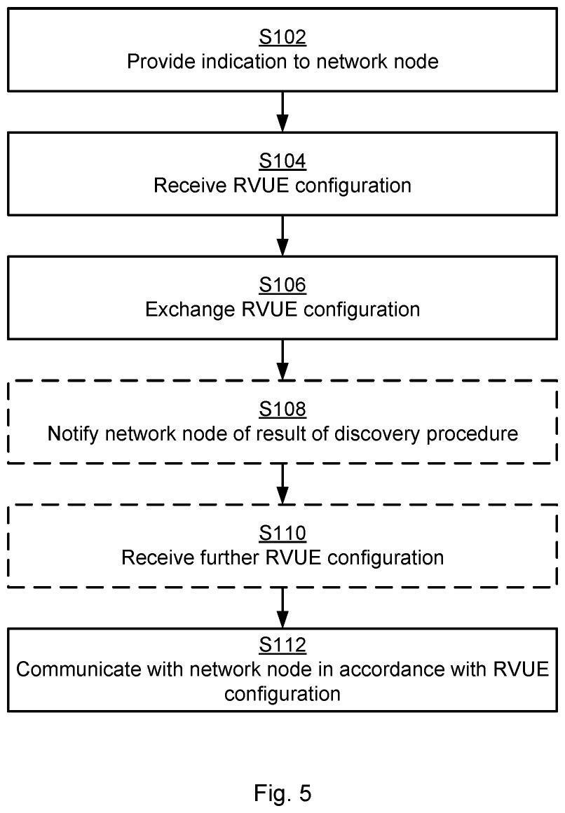

Reference is now made to FIG. 5 illustrating a method for forming a RVUE 400 constituted by a group of transceiver devices 200 as performed by the transceiver device 200 according to an embodiment. The transceiver device 200 is part of the group of transceiver devices 200.

S102: The transceiver device 200 provides an indication to a network node 300 in a network that the transceiver device 200 is capable to operate as part of an RVUE 400.

S104: The transceiver device 200 receives RVUE 400 configuration from the network node 300.

S106: The transceiver device 200 exchanges, without involving the network, the RVUE 400 configuration with at least one other transceiver device 200 in the group of transceiver devices 200 for the group of transceiver devices 200 to form the RVUE 400.

S112: The transceiver device 200 communicates with the network node 300 in accordance with the RVUE 400 configuration.

Embodiments relating to further details of forming a RVUE 400 constituted by a group of transceiver devices 200 as performed by the transceiver device 200 will now be disclosed with continued reference to FIG. 5.

There may be different types of information included in the indication that is provided to the network node 300 in step S102. Different embodiments relating thereto will now be described in turn.

In some embodiments, previous sounding, or discovery, has been performed between the transceiver devices 200.

The transceiver device 200 might then in the indication provided information that the sounding, or discovery, between the transceiver devices 200 has already been performed. Particularly, in some embodiments, the indication comprises information that the transceiver device 200 has taken part in a peer-to-peer discovery procedure with the at least one other transceiver device 200.

The network node 300 might then instruct the transceiver devices 200 to form the RVUE 400. Therefore, in some embodiments, the RVUE 400 configuration as received in step S104 comprises instructions that the RVUE 400 is to be formed by the transceiver device 200 and the at least one other transceiver device 200.

There might be different reasons for the transceiver device 200 to provide the indication to the network node 300 in step S102.

In some aspects, the indication is provided in response to one or more transceiver device 200 having joined the group of transceiver devices 200. That is, in some embodiments, the indication is provided in response to the transceiver device 200 having taken part in the peer-to-peer discovery procedure and during the peer-to-peer discovery period having discovered that the at least one other transceiver device 200 has joined the group of transceiver devices 200.

In some aspects, the indication is provided in response to one or more transceiver devices 200 having left the group of transceiver devices 200. That is, in some embodiments, the indication is provided in response to the transceiver device 200 having discovered that at least one further transceiver device 200 has left the group of transceiver devices 200.

In some embodiments, previous sounding, or discovery, has not been performed between the transceiver devices 200.

The RVUE 400 configuration might then include instructions for the transceiver devices 200 to perform sounding, or discovery, between the transceiver devices 200. Particularly, in some embodiments, the RVUE 400 configuration comprises instructions for the transceiver device 200 to take part in a peer-to-peer discovery procedure with the at least one other transceiver device 200. Exchanging the RVUE 400 configuration with the at least one other transceiver device 200 involves taking part in the peer-to-peer discovery procedure with the at least one other transceiver device 200.

In this respect, one of the transceiver devices 200 (e.g., acting as a coordinating transceiver device 200 in the group of the transceiver devices 200) might query other transceiver devices 200 that are discoverable if these discoverable transceiver devices 200 want to join the RVUE 400. The discoverable transceiver devices 200 then responds if they want to join the RVUE 400 or not. That is, in some embodiments, as part of taking part in the peer-to-peer discovery procedure, the transceiver device 200 queries the at least one other transceiver device 200 whether the at least one other transceiver device 200 is capable of being part of the RVUE 400 or not and receives information from the at least one other transceiver device 200 that the at least one other transceiver device 200 is capable of being part of the RVUE 400.

In further detail, one of the transceiver devices 200 (e.g., the one acting as the coordinating transceiver device 200 in the group of the transceiver devices 200) might coordinate operations of the RVUE 400 such as communication with the network, control inclusion of new transceiver devices 200 in the RVUE 400, exclusion of transceiver devices 400 from the RVUE 400, etc.

The role of coordinating transceiver device 200 might be assigned to a transceiver device 200 that has enough capabilities to act as coordinating transceiver device 200.

There might be different types of information exchanged between the transceiver devices 200 during the peer-to-peer discovery procedure. In some examples, the transceiver devices 200 exchange information with respect to device status and capabilities (e.g., antenna capability, power/battery status, compute resources), connectivity between transceiver devices 200 (e.g., type of connection (e.g. protocol)), capabilities (e.g. capacity, type of wireless connection interface, type of wired connection interface, New Radio (NR) sidelink connection capabilities, Bluetooth connection capabilities, Wi-Fi connection capabilities, latency of the connection), connectivity between transceiver devices 200 and the network (e.g., multiple input multiple output (MIMO) communication capabilities, antennas, antenna ports, operational frequency, operational bandwidth).

The transceiver device 200 (e.g., the one acting as the coordinating transceiver device 200 in the group of the transceiver devices 200) might then inform the network node 300 of the result of the sounding, or discovery. In particular, in some embodiments, the transceiver device 200 is configured to perform (optional) step S108.

S108: The transceiver device 200 notifies the network node 300 of a result of the peer-to-peer discovery procedure. The result at least indicates which other transceiver devices 200, and/or how many other transceiver devices 200, the transceiver device 200 is capable of communicating with without involving the network.

The network node 300 might then instruct the transceiver devices 200 to form the RVUE 400. In particular, in some embodiments, the transceiver device 200 is configured to perform (optional) step S110.

S110: The transceiver device 200 receives further RVUE 400 configuration from the network node 300. The further RVUE 400 configuration comprises instructions that the RVUE 400 is to be formed by the transceiver device 200 and the at least one other transceiver device 200.

Embodiments applicable regardless of previous sounding, or discovery, has or has not been performed between the transceiver devices 200 will be disclosed next.

In some embodiments, the indication comprises an identifier of the transceiver device 200. There could be different types of such identifiers. In some examples, the identifier is a cell radio network temporary identifier (C-RNTI). In some examples, identifiers of some, or even all, the transceiver devices 200 in the group of transceiver devices 200 are provided in the indication.

In some examples, the indication is part of normal UE capability signaling.

Since the different transceiver devices 200 that belong to the group of transceiver devices 200 may belong to different classes and have different capabilities, such as, number of ports, frequency bands, etc. (with more examples having been provided above), the transceiver device 200 might in the indication in S102 include information of the overall capabilities and classes of the group of transceiver devices 200 to the network node 300. In cases where the network classifies transceiver devices 200 into different classes depending on device capabilities, requirements, etc., a RVUE 400 can be a new special class with reconfigurable capabilities, or requirements. Therefore, in some embodiments, the indication comprises information of capabilities of the transceiver device 200 and, optionally, of the at least one other transceiver device 200 in the group of transceiver devices 200. In some non-limiting examples, the capabilities pertain to any, or any combination, of: antenna capability, power and/or battery status, computational resources, inter-connectivity capabilities to other transceiver devices 200 in the group of transceiver devices 200, connectivity capabilities to the network usable for the RVUE 400.

In further examples, the indication comprises information of capabilities of the transceiver device 200 and, optionally, of the at least one other transceiver device 200 in the group of transceiver devices 200. In some non-limiting examples, the capabilities pertain to any, or any combination, of: number of transmission ports, number of reception ports, supported frequency bands, antenna coherence capability, maximum output power.

In yet further examples, the indication comprises information of capabilities pertaining to any, or any combination, of: spatial distance between the transceiver devices 200 in the group of transceiver devices 200, coherency capabilities between the transceiver devices 200 in the group of transceiver devices 200, synchronization capabilities between the transceiver devices 200 in the group of transceiver devices 200. For example, when beamforming is used for communication between the transceiver devices 200 and the network node 300, in case the distance is very small, the same beam can be expected to be used for all transceiver devices 200 constituting an RVUE 400, whilst if the distance is large, then separate beams might be needed for the communication with the different transceiver devices 200 constituting one and the same RVUE 400.

Aspects of the RVUE 400 configuration will be disclosed next.

There might be different examples of RVUE 400 configuration that the transceiver device 200 receives from the network node 300 in step S104. In some embodiments, the RVUE 400 configuration comprises information in terms of any, or any combination, of: an association between uplink reference signal resources and the transceiver devices 200 in the group of transceiver devices 200, an association between uplink control information resources and the transceiver devices 200 in the group of transceiver devices 200.

Aspects of exchanging the RVUE 400 configuration will be disclosed next.

As disclosed above, the transceiver device 200 in step S106, upon having received the RVUE 400 configuration from the network node 300 in step S104, exchanges, without involving the network, the RVUE 400 configuration with at least one other transceiver device 200 in the group of transceiver devices 200 for the group of transceiver devices 200 to form the RVUE 400. In some embodiments, exchanging the RVUE 400 configuration with the at least one other transceiver device 200 involves informing the at least one other transceiver device 200 that the RVUE 400 is to be formed with the transceiver device 200.

Aspects of the transceiver device 200 communicating with the network node 300 in accordance with the RVUE 400 configuration will be disclosed next.

Depending on the amount of data to be transmitted from, and received by, the RVUE 400, and also depending on the capabilities of the RVUE 400, either single-stream transmission and/or reception can be used or multi-stream transmission and/or reception can be used. That is, in some embodiments, communicating with the network node 300 in accordance with the RVUE 400 configuration comprises performing a multi-stream transmission towards, and/or a multi-stream reception from, the network node 300. For example, there could be two or more simultaneous transmissions from the RVUE 400 towards the network node 300 and/or two or more simultaneous transmissions from the network node 300 towards the network node 400. Further, this could also imply that, simultaneously, one of the transceiver devices 200 in the RVUE 400 receives data from the network node 300 whilst another of the transceiver devices 200 in the RVUE 400 transmits data towards the network node 300. At least one stream of the multi-stream transmission and/or the multi-stream reception comprises data belonging to the at least one other transceiver device 200. Data belonging to the at least one other transceiver device 200 here thus refers to data that is either transmitted towards the at least one other transceiver device 200 or data transmitted from the at least one other transceiver device 200.

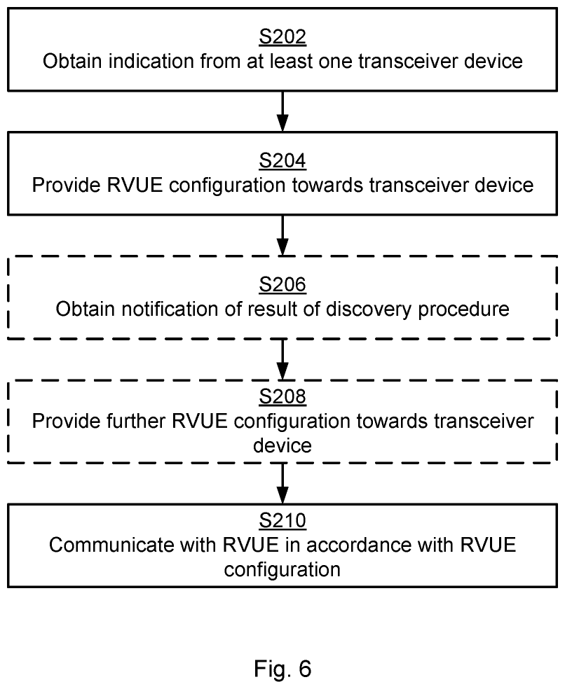

Reference is now made to FIG. 6 illustrating a method for forming a RVUE 400 constituted by a group of transceiver devices 200 as performed by the network node 300 according to an embodiment.

S202: the network node 300 obtains an indication from at least one of the transceiver devices 200 in the group of transceiver device 200 that the at least one of the transceiver devices 200 is capable to operate as part of an RVUE 400.

S204: the network node 300 provides RVUE 400 configuration towards the at least one of the transceiver devices 200.

S210: the network node 300 communicates with the RVUE 400 in accordance with the RVUE 400 configuration.

Embodiments relating to further details of forming a RVUE 400 constituted by a group of transceiver devices 200 as performed by the network node 300 will now be disclosed with continued reference to FIG. 6.

As disclosed above, in some embodiments, previous sounding, or discovery, has been performed between the transceiver devices 200. As further disclosed above, the transceiver device 200 might then in the indication provided information that the sounding, or discovery, between the transceiver devices 200 has already been performed. Hence, in some embodiments, the indication comprises information that the at least one of the transceiver devices 200 has taken part in a peer-to-peer discovery procedure with at least one other transceiver device 200 in the group of transceiver devices 200. The network node 300 might then instruct the transceiver devices 200 to form the RVUE 400. Therefore, in some embodiments, the RVUE 400 configuration comprises instructions that the RVUE 400 is to be formed by the at least one of the transceiver devices 200 and the at least one other transceiver device 200.

As disclosed above, in some embodiments, previous sounding, or discovery, has not been performed between the transceiver devices 200. The RVUE 400 configuration might then include instructions for the transceiver devices 200 to perform sounding, or discovery, between the transceiver devices 200. Particularly, in some embodiments, the RVUE 400 configuration comprises instructions for the at least one of the transceiver devices 200 to take part in a peer-to-peer discovery procedure with other transceiver devices 200 in the group of transceiver devices 200.

As disclosed above, one of the transceiver devices 200 might inform the network node 300 of the result of the sounding, or discovery. In particular, in some embodiments, the network node 300 is configured to perform (optional) step S206.

S206: The network node 300 obtains a notification from the at least one of the transceiver devices 200 of a result of the peer-to-peer discovery procedure. The result at least indicates which other transceiver devices 200, and/or how many other transceiver devices 200, the at least one of the transceiver devices 200 is capable of communicating with without involving the network.

The network node 300 might then instruct the transceiver devices 200 to form the RVUE 400. In particular, in some embodiments, the network node 300 is configured to perform (optional) step S208.

S208: The network node 300 provides further RVUE 400 configuration towards the at least one of the transceiver devices 200. The further RVUE 400 configuration comprises instructions that the RVUE 400 is to be formed by the at least one of the transceiver devices 200 and at least one of the other transceiver devices 200.

Embodiments applicable regardless of previous sounding, or discovery, has or has not been performed between the transceiver devices 200 will be disclosed next.

As disclosed above, in some embodiments, the indication comprises an identifier of the transceiver device 200.

As further disclosed above, in some embodiments, the indication comprises information of capabilities of the at least one of the transceiver devices 200 and, optionally, at least one other transceiver device 200 in the group of transceiver devices 200. In some non-limiting examples, the capabilities pertain to any, or any combination, of: antenna capability, power and/or battery status, computational resources, inter-connectivity capabilities to other transceiver devices 200 in the group of transceiver devices 200, connectivity capabilities to the network usable for the RVUE 400.

As further disclosed above, in some examples, the indication comprises information of capabilities of the at least one of the transceiver devices 200 and, optionally, at least one other transceiver device 200 in the group of transceiver devices 200. In some non-limiting examples, the capabilities pertain to any, or any combination, of: number of transmission ports, number of reception ports, supported frequency bands, antenna coherence capability, maximum output power.

As further disclosed above, in further examples, the indication comprises information of capabilities pertain to any, or any combination, of: spatial distance between the transceiver devices 200 in the group of transceiver devices 200, coherency capabilities between the transceiver devices 200 in the group of transceiver devices 200, synchronization capabilities between the transceiver devices 200 in the group of transceiver devices 200.

As disclosed above, in some embodiments, the RVUE 400 configuration comprises an indicator for one of the at least one of the transceiver devices 200 to act as coordinator transceiver device 200 for the RVUE 400, wherein the capabilities for the one of the at least one of the transceiver devices 200 fulfil a communication criterion for communicating with the network node 300 and with the group of transceiver devices 200.

As disclosed above, in some embodiments, the RVUE 400 configuration RVUE 400 configuration comprises information in terms of any, or any combination, of: an association between uplink reference signal resources and the transceiver devices 200 in the group of transceiver devices 200, an association between uplink control information resources and the transceiver devices 200 in the group of transceiver devices 200.

As disclosed above, in some embodiments, the RVUE 400 configuration instructs the transceiver devices 200 constituting the RVUE 400 to perform a multi-stream transmission towards and/or a multi-stream reception from, the RVUE 400, where at least two of the streams of the multi-stream transmission and/or the multi-stream reception comprise data belonging to two different transceiver devices 200 in the group of transceiver devices 200. In this respect, the network node 300 might instruct transceiver devices 200 whose channels towards the network node 300 are not too correlated for the multi-stream transmission and/or the multi-stream reception to be performed.

Some scenarios where the herein disclosed embodiments are directly applicable will be disclosed next.

A first scenario concerns collaborative sensing. An RVUE 400, by means of its group of spatially separated transceiver devices 200, can be utilized for accurate sensing. For example, group of spatially separated transceiver devices 200 can perform more accurate location estimation of objects than one individual transceiver device 200.

A second scenario concerns collaborative CPEs. CPEs in a fixed wireless access (FWA) deployment can form a RVUE 400. For example, multiple CPEs strategically deployed in a building can together achieve improved connectivity to the network compared to a single CPE.

A third scenario concerns multi-stream transmission and reception. As disclosed above, for example with reference to FIGS. 3 and 4, an RVUE 400 can be used for adding spatial diversity and/or multiplexing. This is possible since the RVU has higher number of antenna ports than any of the individual transceiver devices 200. An RVUE 400 can thus be utilized for multi-stream transmission and reception to/from the network and utilize all available antennas to do so. This contrasts with legacy cellular communication systems in which each of the plurality of UEs needs to be separately scheduled.

A fourth scenario concerns alternative network deployments. RVUE 400s can be used as an alternative to deploying more access nodes in the network to achieve better coverage.

A fifth scenario concerns a situation where interference suppression can be improved by the transceiver devices forming an RVUE 400.

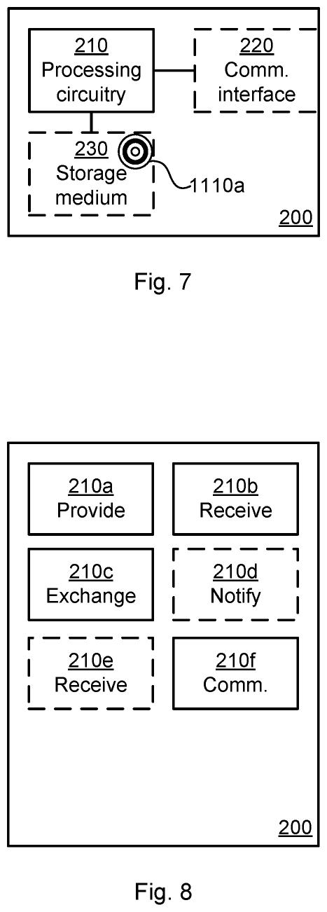

FIG. 7 schematically illustrates, in terms of a number of functional units, the components of a transceiver device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the transceiver device 200 to perform a set of operations, or steps, as disclosed above. For example, the storage medium 230 may store the set of operations, and the processing circuitry 210 may be configured to retrieve the set of operations from the storage medium 230 to cause the transceiver device 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The transceiver device 200 may further comprise a communications (comm.) interface 220 for communications with other entities, functions, nodes, and devices, such as other transceiver devices 200 as well as the network node 300. As such the communications interface 220 may comprise one or more transmitters and receivers, comprising analogue and digital components.

The processing circuitry 210 controls the general operation of the transceiver device 200 e.g. by sending data and control signals to the communications interface 220 and the storage medium 230, by receiving data and reports from the communications interface 220, and by retrieving data and instructions from the storage medium 230. Other components, as well as the related functionality, of the transceiver device 200 are omitted in order not to obscure the concepts presented herein.

FIG. 8 schematically illustrates, in terms of a number of functional modules, the components of a transceiver device 200 according to an embodiment. The transceiver device 200 of FIG. 8 comprises a number of functional modules; a provide module 210a configured to perform step S102, a receive module 210b configured to perform step S104, an exchange module 210c configured to perform step S106, and a communicate (Comm.) module 210f configured to perform step S112. The transceiver device 200 of FIG. 8 may further comprise a number of optional functional modules, such as any of a notify module 210d configured to perform step S108, a receive module 210e configured to perform step S110. In general terms, each functional module 210a:210f may be implemented in hardware or in software. Preferably, one or more or all functional modules 210a:210f may be implemented by the processing circuitry 210, possibly in cooperation with the communications interface 220 and/or the storage medium 230. The processing circuitry 210 may thus be arranged to from the storage medium 230 fetch instructions as provided by a functional module 210a:210f and to execute these instructions, thereby performing any steps of the transceiver device 200 as disclosed herein.

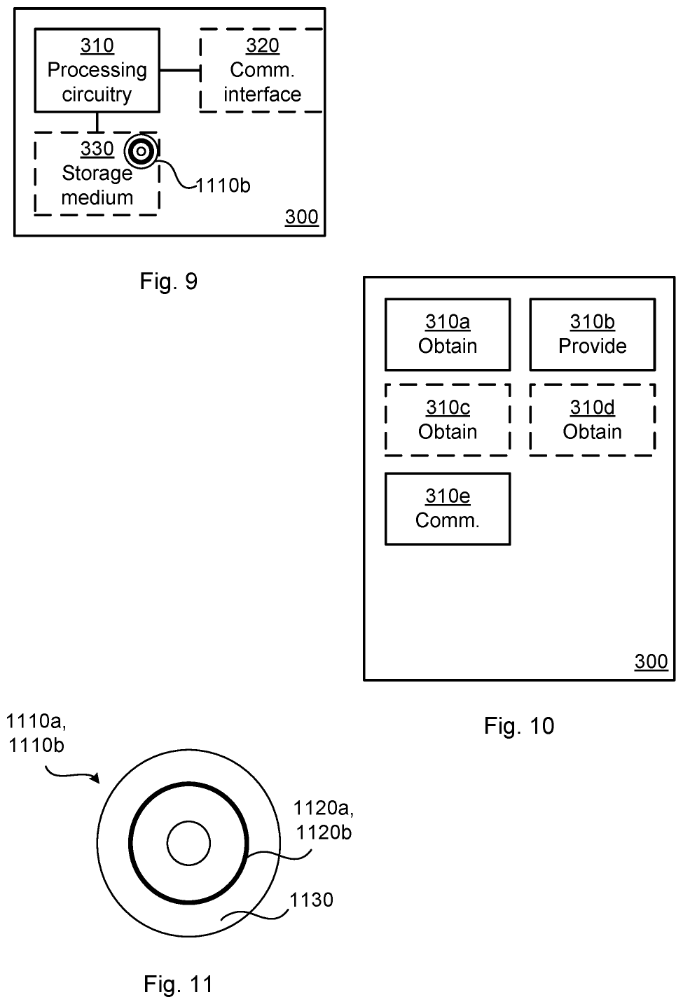

FIG. 9 schematically illustrates, in terms of a number of functional units, the components of a network node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 11), e.g. in the form of a storage medium 330. The processing circuitry 310 may further be provided as at least one application specific integrated circuit (ASIC), or field programmable gate array (FPGA).

Particularly, the processing circuitry 310 is configured to cause the network node 300 to perform a set of operations, or steps, as disclosed above. For example, the storage medium 330 may store the set of operations, and the processing circuitry 310 may be configured to retrieve the set of operations from the storage medium 330 to cause the network node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The network node 300 may further comprise a communications interface 320 for communications with other entities, functions, nodes, and devices, such as with individual transceiver devices 200 as well as with an RVUE 400 constituted by a group of transceiver devices 200. As such the communications interface 320 may comprise one or more transmitters and receivers, comprising analogue and digital components.

The processing circuitry 310 controls the general operation of the network node 300 e.g. by sending data and control signals to the communications interface 320 and the storage medium 330, by receiving data and reports from the communications interface 320, and by retrieving data and instructions from the storage medium 330. Other components, as well as the related functionality, of the network node 300 are omitted in order not to obscure the concepts presented herein.

FIG. 10 schematically illustrates, in terms of a number of functional modules, the components of a network node 300 according to an embodiment. The network node 300 of FIG. 10 comprises a number of functional modules; an obtain module 310a configured to perform step S202, a provide module 310b configured to perform step S204, and a communicate (Comm.) module 310e configured to perform step S210. The network node 300 of FIG. 10 may further comprise a number of optional functional modules, such as any of an obtain module 310c configured to perform step S206, and an obtain module 310d configured to perform step S208. In general terms, each functional module 310a:310e may be implemented in hardware or in software. Preferably, one or more or all functional modules 310a:310e may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310e and to execute these instructions, thereby performing any steps of the network node 300 as disclosed herein.

The network node 300 may be provided as a standalone device or as a part of at least one further device. For example, the network node 300 may be provided in a node of a (radio) access network or in a node of a core network. Alternatively, functionality of the network node 300 may be distributed between at least two devices, or nodes. These at least two nodes, or devices, may either be part of the same network part (such as the (radio) access network or the (core) network) or may be spread between at least two such network parts. In general terms, instructions that are required to be performed in real time may be performed in a device, or node, operatively closer to a cell served by the network node 300 than instructions that are not required to be performed in real time.

Thus, a first portion of the instructions performed by the network node 300 may be executed in a first device, and a second portion of the instructions performed by the network node 300 may be executed in a second device; the herein disclosed embodiments are not limited to any particular number of devices on which the instructions performed by the network node 300 may be executed. Hence, the methods according to the herein disclosed embodiments are suitable to be performed by a network node 300 residing in a cloud computational environment. Therefore, although a single processing circuitry 310 is illustrated in FIG. 9 the processing circuitry 310 may be distributed among a plurality of devices, or nodes. The same applies to the functional modules 310a:310e of FIG. 10 and the computer program 1120b of FIG. 11.

FIG. 11 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any steps of the transceiver device 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any steps of the network node 300 as herein disclosed.

In the example of FIG. 11, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-42. (canceled)

43. A method for forming a reconfigurable virtual user equipment (RVUE) comprising a group of transceiver devices comprising a first transceiver device and a second transceiver device, the method comprising:
the first transceiver device providing an indication to a network node in a network that the first transceiver device is capable to operate as part of an RVUE;
the first transceiver device receiving an RVUE configuration from the network node;
the first transceiver device providing, without involving the network, the RVUE configuration to the second transceiver device in the group of transceiver devices; and
the first transceiver device communicating with the network node in accordance with the RVUE configuration.

44. The method of claim 43, wherein the indication comprises information that the first transceiver device has taken part in a peer-to-peer discovery procedure with the second transceiver device.

45. The method of claim 44, wherein the RVUE configuration comprises instructions that the RVUE is to be formed by the first transceiver device and at least the second transceiver device.

46. The method of claim 44, wherein the indication is provided in response to the first transceiver device having taken part in the peer-to-peer discovery procedure and during the peer-to-peer discovery period having discovered that the second transceiver device has joined the group of transceiver devices.

47. The method of claim 43, wherein the indication is provided in response to the first transceiver device having discovered that a third transceiver device has left the group of transceiver devices.

48. The method of claim 43, wherein
the RVUE configuration comprises instructions for the first transceiver device to take part in a peer-to-peer discovery procedure with the second transceiver device, and
providing the RVUE configuration to the second transceiver device involves taking part in the peer-to-peer discovery procedure with the second transceiver device.

49. The method of claim 48, wherein, as part of taking part in the peer-to-peer discovery procedure, the first transceiver device queries the second transceiver device whether the second transceiver device is capable of being part of the RVUE or not and receives information from the second transceiver device that the second transceiver device is capable of being part of the RVUE.

50. The method of claim 48, wherein
the method further comprises notifying the network node of a result of the peer-to-peer discovery procedure, and
the result indicates:
which other transceiver devices the first transceiver device is capable of communicating with without involving the network, and/or
how many other transceiver devices the first transceiver device is capable of communicating with without involving the network.

51. The method of claim 50, wherein
the method further comprises receiving further RVUE configuration from the network node, and
the further RVUE configuration comprising instructions that the RVUE is to be formed by the first transceiver device and the second transceiver device.

52. The method of claim 43, wherein the indication comprises an identifier of the first transceiver device.

53. The method of claim 43, wherein
at least one of the transceiver devices in the group of transceiver devices has a network identity, and
the network identity is used by all of the transceiver devices in the group of transceiver devices when communicating with the network node in accordance with the RVUE configuration.

54. The method of claim 43, wherein
communicating with the network node in accordance with the RVUE configuration comprises performing a multi-stream transmission towards and/or a multi-stream reception from the network node, and
at least one stream of the multi-stream transmission and/or the multi-stream reception comprises data belonging to the second transceiver device.

55. A method for forming a reconfigurable virtual user equipment (RVUE) comprising by a group of transceiver devices comprising a first transceiver device and a second transceiver device, wherein the method is performed by a network node in a network, and the method comprises:
obtaining from the first transceiver device in the group of transceiver devices an indication indicating that the first transceiver device is capable to operate as part of an RVUE;
providing RVUE configuration towards the first transceiver device; and
communicating with the RVUE in accordance with the RVUE configuration.

56. The method of claim 55, wherein the indication comprises information that the first transceiver device has taken part in a peer-to-peer discovery procedure.

57. The method of claim 56, wherein the RVUE configuration comprises instructions that the RVUE is to be formed by the first transceiver device and at least the second transceiver device.

58. The method of claim 55, wherein the RVUE configuration comprises instructions for the first transceiver device to take part in a peer-to-peer discovery procedure.

59. The method of claim 58, wherein
the method further comprises obtaining from the first transceiver device a notification of a result of the peer-to-peer discovery procedure, and
the result indicates:
which other transceiver devices the first transceiver device is capable of communicating with without involving the network, and/or
how many other transceiver devices the first transceiver device is capable of communicating with without involving the network.

60. The method of claim 59, wherein
the method further comprises providing further RVUE configuration towards the first transceiver device, and
the further RVUE configuration comprising instructions that the RVUE is to be formed by the first transceiver device and at least on other transceiver device.

61. A first transceiver device for forming a reconfigurable virtual user equipment (RVUE) comprising a group of transceiver devices comprising the first transceiver device and a second transceiver device, the first transceiver device comprising:
memory; and
processing circuitry, wherein the first transceiver device is configured to perform a method comprising:
providing an indication to a network node in a network that the first transceiver device is capable to operate as part of an RVUE;
receiving an RVUE configuration from the network node;
providing, without involving the network, the RVUE configuration to the second transceiver device in the group of transceiver devices; and
communicating with the network node in accordance with the RVUE configuration.

62. A network node for forming a reconfigurable virtual user equipment (RVUE) comprising a group of transceiver devices comprising a first transceiver device and a second transceiver device, the network node comprising:
memory; and
processing circuitry, wherein the network node is configured to perform a method comprising:
obtaining from the first transceiver device in the group of transceiver devices an indication indicating that the first transceiver device is capable to operate as part of an RVUE;
providing RVUE configuration towards the first transceiver device; and
communicating with the RVUE in accordance with the RVUE configuration.
